(19) United States
(12) Patent Application Publication
(10) Pub. No.: US 2008/0179453 A1
(43) Pub. Date: Jul. 31, 2008

(54) Modular airship system and method

(76) Inventor: Mark N. Thompson, Dewey, IL (US)

Correspondence Address: BRINKS HOFER GILSON & LIONE, P.O. BOX 10395, CHICAGO, IL, 60610, US

(21) Appl. No.: 11/698,969

(22) Filed: Jan. 26, 2007

(51) Int. Cl. B64B 1/00

(52) U.S. Cl. 244/30

(57) ABSTRACT

A modular airship system capable of assembling and disassembling two or more modular airships while in flight. The assembled modular airships providing improved lift and loft characteristics, while the disassembled modular airships provide for improved ground handling, storage, and transport. The modular airship comprises a coupling device to couple two or more modular airships together while in flight. The coupling device may include an electromagnetic attachment, a shaft and socket, Velcro, a latch, a draw cord, or a combination thereof. The modular airship may also have a propulsion system and the capability to carry a payload. The modular airship further comprises an electrical communication system which allows the two or more modular airships, when coupled together, to permit navigation, monitoring, and/or power systems to be shared and/or synchronized. It can be appreciated that the modular airships may also be coupled together on the ground prior to flight and may be replenished while in flight by another modular airship or aircraft. In a preferred embodiment, the modular airship may have the shape of an airfoil.

### BACKGROUND

Airships may be used to carry bulky loads, over varying regions and through varying flight conditions, such as high altitude flight, over large bodies of water, or mountainous areas in varying regions of the world. However, in order to carry such large loads for extended periods or operate in high altitudes, an airship must typically be large and, as a result, bulky. The size and weight of conventional heavy-lifting airships present several problems ranging from difficulty in the handling of the airship during loading and take-off to storage and transportation limitations due to the large size.

For example, conventional airships having larger sizes are difficult to handle on the ground during takeoff and landing, often requiring a large number of people to grab lines during loading, or utilize additional equipment to secure the airship and attach the airship to a mooring mast. In addition, large airships require oversized hangers for storage.

Another problem associated with conventional airships is the increased space requirements for ground-handling facilities. For instance, more land area is necessary to handle these airships during loading or off-loading of a payload. Airships having smaller sizes have been developed to circumvent storage limitations. However, these smaller sized airships are not as efficient for carrying large payloads, such as cargo, fuel, and supplies.

Accordingly, there is a need for an airship that provides a large payload capacity while also providing increased handling ability. Additionally, there is a further need for an airship which can be conveniently disassembled and stored in a relatively small space.

### BRIEF DESCRIPTION OF THE DRAWINGS

FIG. 1 is a perspective view of a modular airship in accordance with one embodiment.

FIG. 2 is a perspective view of the modular airship of FIG. 1 wherein a frame is external to an envelope.

FIG. 3 is a perspective view of the airship of FIG. 1 wherein a frame is internal to an envelope.

FIG. 4 is a perspective view of two modular airships coupled together.

FIG. 5 is a front perspective view of the modular airships of FIG. 4.

FIG. 6 is a rear perspective view of the modular airships of FIG. 4.

### DETAILED DESCRIPTION OF EMBODIMENTS

The following detailed description and appended drawings describe and illustrate various exemplary embodiments of the invention. The description and drawings serve to enable one skilled in the art to make and use the invention, and are not intended to limit the scope of the invention in any manner.

The disclosed embodiments relate to a modular airship and more particularly to an improved modular airship system for assembling and disassembling multiple modular airships while in flight, the assembled modular airships providing improved lift and loft characteristics while the individual disassembled modular airships provide for improved ground handling, storage, and transport. It can be appreciated that individual modular airships may be stored and assembled in multiple hangers, and assembled together on the ground prior to operation As used herein, the term “airship” means any air vessel that provides a housing structure to secure a lighter-than-air gas, including but not limited to a blimp, fuselage, airfoil, or spaceship. The disclosed modular airship features a coupling device that is capable of coupling the modular airship together with one or more other modular airships while in flight. As used herein, the term “in flight” means that the modular airships are free from a physical ground connection, and may be controlled remotely by an automated or manually operated remote control device, an on-board autonomous control system, a manual control system, manually by a pilot, or a combination thereof. The modular airship may further include an electrical communication system that is capable of facilitating communications between the two or more coupled modular airships, such as to share electrical power or control systems. As used herein, the term “coupled with” means directly connected to or indirectly connected through one or more intermediate components, including but not limited to the structure of the airship.

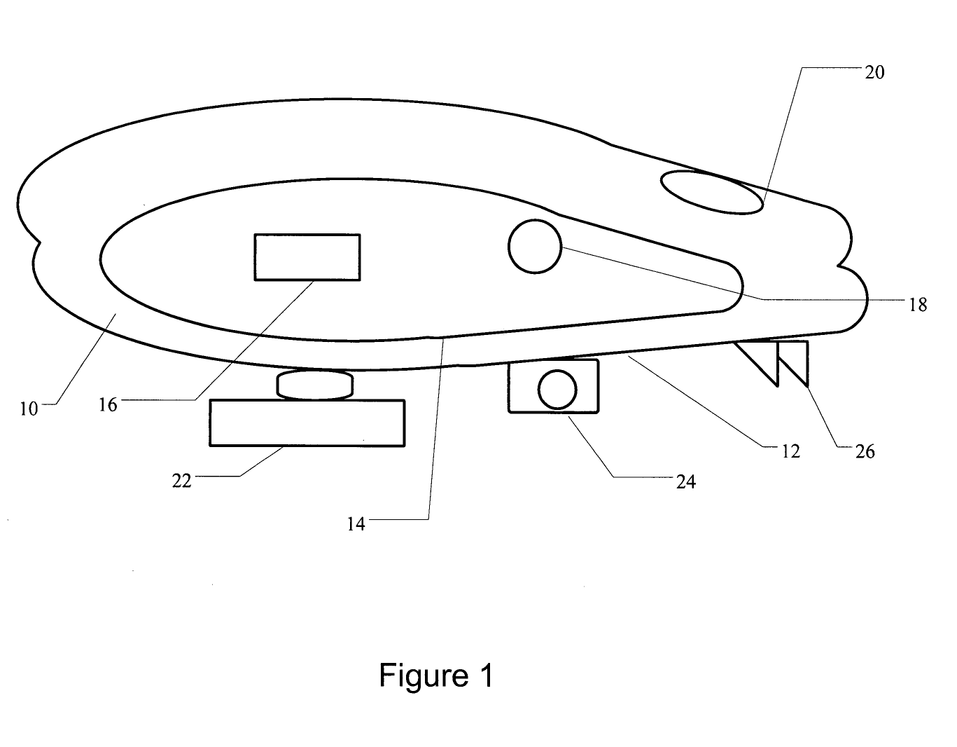

FIG. 1 shows a perspective view of a modular airship 10 in accordance with one embodiment. The modular airship 10 includes a frame 12 and an envelope 14 disposed within, or alternatively, around the frame 12. The modular airship 10 also includes a coupling device 16 coupled with at least a portion of the frame 12 or, alternatively, the envelope 14. The coupling device 16 is operative to couple the modular airship 10 together with another modular airship 10 (not shown).

The coupling device 16 may include an electromagnetic attachment, a shaft and socket, Velcro, a latch, a draw cord, or a combination thereof, or other suitable coupling mechanism presently known or later developed. In one embodiment, the coupling device 16 is a universal device capable of coupling with any other coupling device 16 of another modular airship 10. In an alternative embodiment, the coupling device 16 includes both a “male” component and a “female” component (not shown) which mate with the opposing component of the coupling device 16 of another modular airship 10. The male and female components of the coupling device 16 may be oriented, such as on opposite sides of the modular airship 10, so as to allow each to couple with the opposing component of the coupling devices 16 of two separate modular airships 10. It will be appreciated that a coupling device 16 of a given modular airship 10 may provide either only male or female components, thereby being able to couple only with a modular airship 10 having a suitable opposing coupling device 16. Alternatively, the modular airship 10 may have a cord, cable or rope (not shown) coupled with a winch assembly (not shown) operative to be engaged by a capture assembly (not shown), such as a hook (not shown) or eyelet (not shown) of another modular airship 10.

A notable feature of the first coupling device 16 is the ability to allow the modular airship 10 to attach and detach with another modular airship 10 while in flight. The first coupling device 16 may further comprises a device to assist in the coupling process, such as by facilitating alignment of the coupling devices 16 of each modular airship 10. For example, the coupling device 16 may further comprise a proximity sensor (not shown) disposed within the frame 12, or the envelope 14 of the first modular airship 10 that can detect the distance and orientation of the other modular airship during the coupling process. Alternatively, the modular airship 10 may have an on-board camera (not shown) or a video display unit (not shown), or other suitable sensor/detector to detect the range and orientation of the other modular airship during the coupling process and provide information to assist and/or control the coupling the process.

The modular airship 10 further comprises a first electrical communication system 18 coupled with the frame 12 or, alternatively, the envelope 14. The first electrical communication system 18, which may include radio frequency, optical, direct electrical communications media, or combinations thereof, allows two or more modular airships 10, when coupled together via the coupling device 16, to be in electrical communication. For example, to permit navigation, monitoring, and/or power systems to be shared and/or synchronized. In one configuration, the flight controls (not shown) of the coupled two or more modular airships 10 may be synchronized via the first electrical communication system 18 to permit the coupled two or more modular airships 10 to be controlled as though they were a single airship, thereby simplifying the handling of the coupled two or more modular airships 10 in flight. Alternatively, or in addition thereto, the first electrical communication system 18 may provide access of one modular airship 10 to functionality provided by another modular airship 10, such as navigation or communications systems, power generation/reserves, light-than-air gas reserves, etc.

In one embodiment, the first coupling device 16 and the first electrical communication system 18 of the modular airship 10 may be combined, where the first coupling device 16 contains an electrical communication system component, such that by coupling the two or more modular airships 10 together with the first coupling device 16, the two or more modular airships 10 will also be in electrical communication.

Optionally, the modular airship 10 may further include a separate fluid communication system (not shown) which allows the modular airships to share the lighter-than-air gas and/or reserves thereof when coupled together. Alternatively, the fluid communication system (not shown) may be incorporated into the first coupling device 16. The fluid communication system (not shown) may be used to facilitate the movement of the lighter-than-air gas between the modular airship 10 and the other modular airship 28. The movement of the lighter-than-air gas may be accomplished by incorporating a valve (not shown) within the first coupling device 16 to allow for gas to transfer from one airship to another when coupled together. In one embodiment, such a system may allow for gas expansion and/or contraction as the airships 10 changed altitude; more information about which may be found in U.S. patent application Ser. No. 11/501,608, incorporated by reference herein.

In one embodiment, the modular airship 10 may further comprise a photo-voltaic array 20, or similar system for converting incident light into electrical energy or into heat energy which may be later used to generate electrical energy or for other purposes, disposed along a portion of the frame 12, or alternatively, the envelope 14. The photo-volatic array 20 allows the modular airship 10 to receive and store solar energy, either in the form of heat energy or electrical energy. Accordingly, an electrical storage system (not shown) may also be disposed within the frame 12 or the envelope 14. The frame 12 is also operative to carry a payload 22, such as communications or surveillance information. Furthermore, the payload 22 may be carried external to the frame 12 and the envelope 14, or alternatively be disposed within the frame 12 or the envelope 14. Thus, the configuration and location of the payload 22 is implementation dependent and may vary, depending on whether the frame 12 is external or internal to the envelope 14. The payload may consist of fuel, supplies, equipment, or a combination thereof.

Further, in another embodiment, a propulsion 24 and/or flight control system 26, such as a rudder 26, may be attached to the frame 12. Alternatively, the propulsion system 24 may be located within the frame 12, such that the propulsion system 24 is not external to the frame 12. The propulsion system 24 may include one or more propellers, a jet based propulsion system, or a combination thereof and may be configured to provide multiple axes of movement. The rudder 26 is used to guide and/or stabilize the modular airship 10 while in flight. The rudder 26 may consist of a single rudder or a plurality of rudders. Further, flaps and other control surfaces (not shown) may be provided

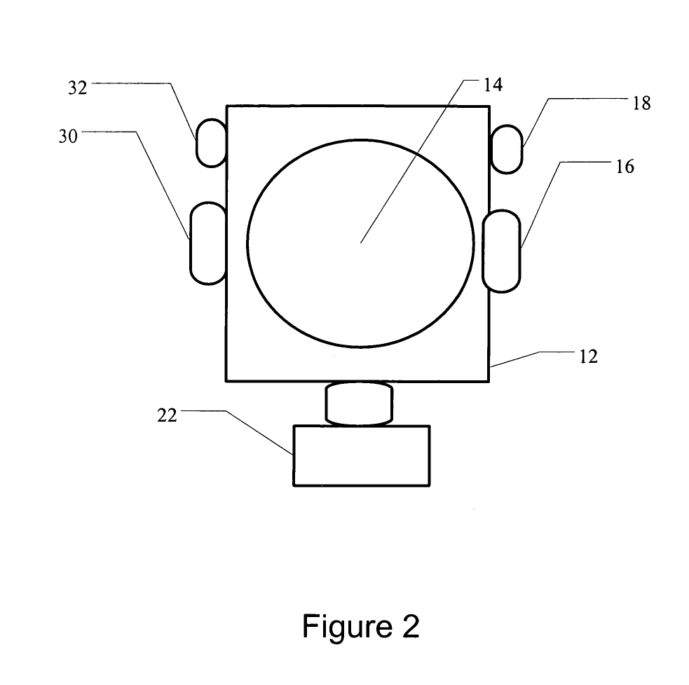

FIG. 2 shows a front perspective view of the modular airship system 10 of FIG. 1 according to one embodiment. In this embodiment, the envelope 14 is disposed within the frame 12. The envelope 14 may be comprised of a single envelope or a series of envelopes that contain a lighter-than-air gas which act in a redundant fashion or, as described above, to handle expansion and contraction of the lighter-than-air gas as the airship 10 changes altitude. In a redundant arrangement, if one envelope of a series of envelopes ruptures, it is not fatal to the operation of the modular airship 10. The first coupling device 16 and the first electrical communication system 18 are external to the frame 12. Alternatively, the first coupling device 16 or the first electrical communication system 18 may be incorporated within the frame 12 such that it would be flush with the frame 12. The payload 22 is mounted under the frame 12, but, alternatively may be disposed between the frame 12 and the envelope 14. The second coupling device 30 and the second electrical communication system 32 are coupled to the frame 12 and are operable to be coupled with another modular airship. As discussed above, a coupling device 16 of a given modular airship 10 may provide either only male or female components, thereby being able to couple only with a modular airship 10 having a suitable opposing coupling device 16. Additionally, the location of the coupling devices and the electrical communication systems may vary and need not be located on the opposite sides of the frame 12, as illustrated in FIG. 2. For example, the components may be located on the top or front portion of the frame 12 instead.

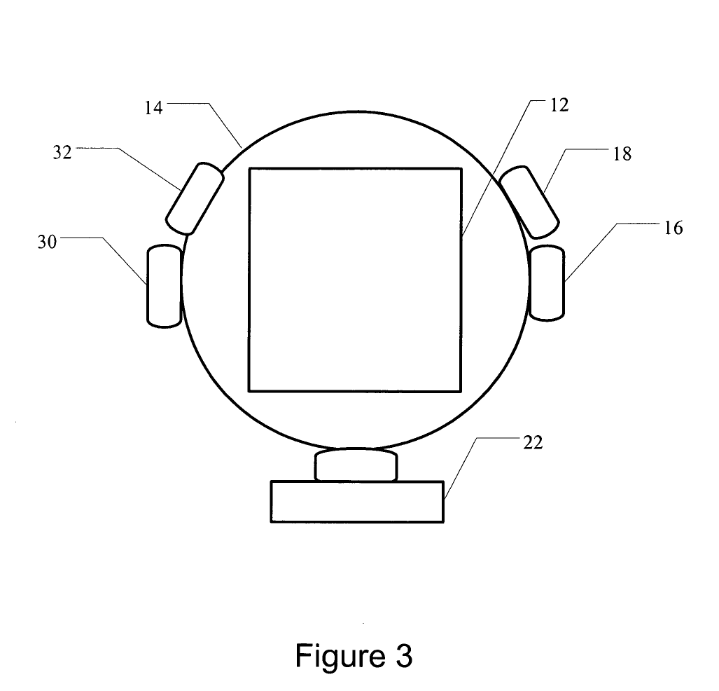

FIG. 3 shows an alternative embodiment of the modular airship system 10, where the envelope 14 is externally coupled with the frame 12. The envelope 14 may be coupled to the frame 12 in such a manner that the shape of the envelope 14 may be defined by the shape of the frame 12. In this embodiment, the first coupling device 16 and first electrical communication system 18 are coupled to the envelope 14 or to a member (not shown) connected to the frame 12. Further, the payload 22 is coupled with either the envelope 14 or to a member (not shown) extending from the frame 12. Alternatively, the payload 22 can be encased within the frame 12 or disposed between the envelope 14 and the frame 12. The propulsion system 24 (not shown) may also be coupled to the envelope 14.

Alternative to the embodiments shown in FIGS. 2 and 3, the frame 12 and envelope 14 may be combined and consist of a shell (not shown). The shell may have structural characteristics of the frame 12, but also have the capability to retain the lighter-than-air gas, similar to the envelope 14. The shell may be sufficiently rigid to support the first coupling device 16, the first electrical communication system 18, and the payload 22, yet also flexible enough to contain the lighter-than-air gas.

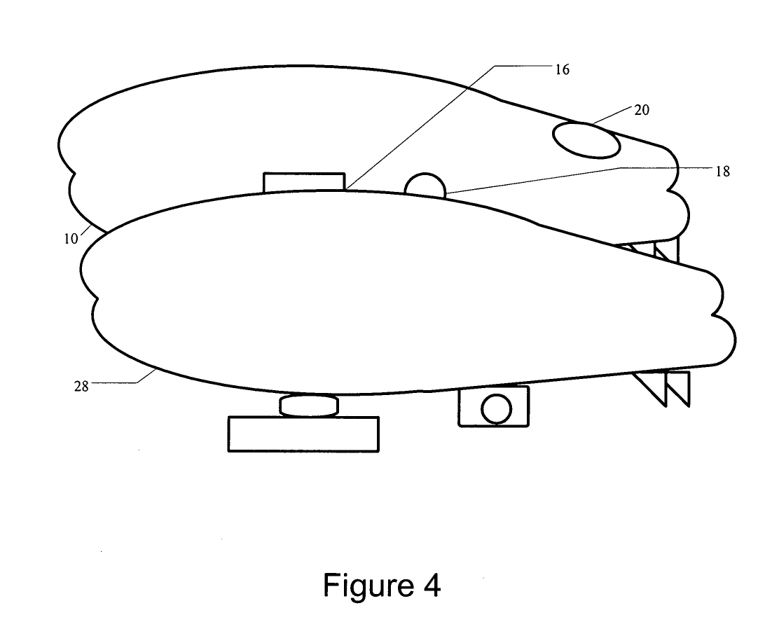

FIGS. 4, 5, and 6 depict the modular airship 10 coupled to another modular airship 28. In one embodiment of the present invention, the modular airship 10 is coupled with the other modular airship 28 while in flight. When the modular airship 10 and the other modular airship 28 are in flight, a user or users communicates with the modular airship 10 to connect with the other modular airship 28, or vice versa. Alternatively, the coupling procedure may be automated. Prior to attachment, the modular airship 10 is positioned adjacent to the other modular airship 28. The modular airships may incorporate a proximity sensor (not shown), an on-board camera (not shown), or a video display unit (not shown) to facilitate the attachment by indicating the location and orientation of the other modular airship 28. The first coupling device 16 is designed to engage a receiving or docking device of the other modular airship 28. A connector of the first electrical communication system 18 is similarly designed to connect to the electrical communication system of the other modular airship 28. When coupled, the propulsion, navigation, and power systems of the modular airship 10 and the other modular airship 28 may be shared and/or synchronized.

If desired, another modular airship (not shown) may connect to the modular airship 10. This feature of linking additional modular airships to the modular airship 10 may continue. It may be necessary that the two or more modular airships 10 be in flight for extended periods of time and possibly over the same location. It can be appreciated that while the two or more modular airships 10 are coupled together in flight, another modular airship 28 may be coupled to the two or more modular airships 10 to perform maintenance tasks, such as but not limited to refueling, recharging, or downloading information from the two or more modular airships 10. Once the other modular airship 28 has performed such tasks, the other modular airship 28 may detach from the two or more modular airships 10. Alternatively, the other modular airship 28 may remain coupled to the two or more modular airships 10, and one of the two or more modular airships 10 may detach.

Furthermore, the other modular airship 28 may have a similar coupling device and electrical communication system such that the other modular airship 28 is capable of attachment to additional airships with a coupling device. However, it is possible that the modular airship 10 and the other modular airship 28 are identical and thus may attach additional modular airships as described above.

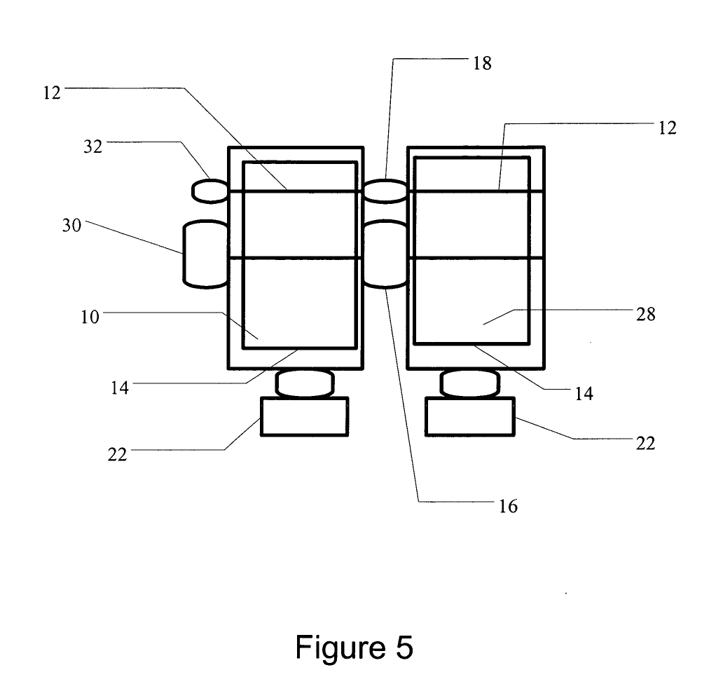

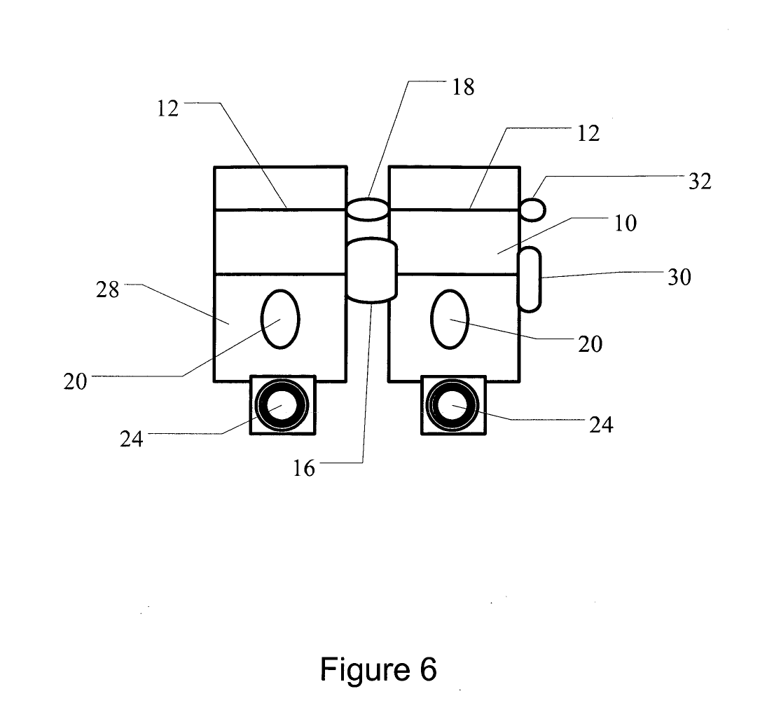

Specifically, as shown in FIGS. 5 and 6, the detachable modular airship 10 has a second coupling device 30 and a second communication device 32 capable of connecting another modular airship capable of communicating with another modular airship. However, in alternative embodiments (not shown) the other modular airship 28 need not necessarily have such components. The other modular airship 28 may only comprise of an envelope, a frame, and a coupling system to which the modular airship 10 may be coupled. It is also not required that the other modular airship 28 have the same shape as the first modular airship 10.

Alternative to the embodiment shown in FIGS. 4, 5, & 6, the modular airships may have multiple attachment configurations, rather than a side by side configuration. For example, the modular airships may be stacked on top of each other or coupled in a front to back configuration. Different attachment configurations may be necessary depending on the tasks required of the modular airships.

The modular airship 10 coupled to the other modular airship 28 may also detach while in flight. As shown in FIGS. 5 and 6, the first coupling device 16 of the modular airship 10 may be actuated to disengage the other modular airship 28. Similarly, the first electrical communication system 18 may be actuated to disengage the other modular airship 28. Alternatively, the other modular airship 28 may be actuated to disengage the modular airship 10. The disengagement of the modular airship 10 may be done by an automated process, by remote control, or by directing the airships to pull apart from each other. However, the modular airship 10 and the other modular airship 28 need not detach while in flight, and may land while coupled together.

The modular airship system 10 may comprise a lighter than air-gas (not shown) disposed within the envelope 14. The lighter than-air gas can include helium, hydrogen, methane, ammonia, hot air, and other gases known in the art.

The composition of the materials used in the components of modular airship system 10 can include polyethylene, nylon, latex, rubber, composite laminate, or other suitable materials having reasonable strength, durability, and retention characteristics. Additionally, the frame 12 or the envelope 14 may include varying shapes and configurations, including but not limited to spherical, circular, ellipsoidal, or variations thereof.

The composition of the material used in the frame 12 of the modular airship 10 can include aluminum, titanium, polymer, composites including carbon fiber, epoxy, or polyimide, or other suitable materials having reasonable strength and durability while still being lightweight.

The components of the modular airship 10, such as the frame 12, can also include variations of thickness and diameter depending on the design and configuration of the modular airship 10.

In other embodiments, the modular airship 10 may comprise of additional structures providing a housing for the components of the modular airship 10, such as a fuselage, an airfoil, or a blimp. In general, the modular airship 10 may also include a variety of shapes, including but not limited to rectangular, circular, triangular, ellipsoidal, or parabolic. For example, the modular airship 10 may comprise a fuselage having a circular shape.

Ideally, the modular airship 10 has a shape of an airfoil, where another modular airship 10 may be attached adjacent to the modular airship 10, thereby increasing the overall lifting surface such that one of the loft or lift capabilities or a combination thereof are increased.

While the invention has been illustrated and described in detail in the drawings and foregoing description, the same is to be considered as illustrative and not restrictive in character, it being understood that only exemplary embodiments have been shown and described and do not limit the scope of the invention in any manner. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

We claim:

1. A modular airship, the airship comprising:
a first envelope operative to contain a volume of lighter-than-air gas; and
a first coupling device capable of attaching the modular airship with another modular airship while in flight.

2. The airship of claim 1, where the modular airship comprises a second coupling device for connecting with the other modular airship.

3. The airship of claim 1, wherein the modular airship is characterized by a shape of an airfoil, such that when the modular and the other modular airships are attached, one of the loft or load capabilities or a combination thereof is increased.

4. The airship of claim 1, wherein the coupling device comprises one of an electromagnetic attachment, a shaft and socket, Velcro, a latch, a draw cord, or a combination thereof.

5. The airship of claim 1, further comprising a photo-voltaic array disposed along a portion of the modular airship.

6. The airship of claim 1, wherein the lighter-than-air gas is selected from the group consisting of hydrogen, helium, or combination thereof.

7. The airship of claim 1, further comprising a propulsion system coupled with the first envelope.

8. The airship of claim 1, further comprising an electrical communication system coupled with the first envelope.

9. The airship of claim 1, wherein the first coupling device allows for fluid communication between the modular airship and the other modular airship.

10. The airship of claim 1, wherein the first envelope of the modular airship is operative to carry a payload.

11. The airship of claim 1, wherein the first coupling device is remotely actuated.

12. The airship of claim 1, wherein the first envelope is coupled with a frame.

13. The airship of claim 12, wherein the frame is external to the first envelope.

14. The airship of claim 12, wherein the frame is internal to the first envelope.

15. A method of assembling a modular airship capable of independent deployment and attachment during operation, the method comprising:
providing at least two airships each having a coupling device for attaching to another airship;
deploying the at least two airships independently into the atmosphere; and
connecting the at least two airships together with the coupling device.

16. The method as recited in claim 15, further providing the at least two airships each having an on-board camera, a video display unit, or a combination thereof for facilitating attachment to another airship.

17. The method as recited in claim 15, further providing another airship to connect with the at least two airships to perform maintenance tasks.

18. The method as recited in claim 15, further comprising synchronizing a control system of the at least two airships.

19. The method as recited in claim 15, further comprising communicating with the at least two airships to control speed, direction, and orientation using a remote control device.

20. A method of assembling a modular airship capable of detachment during operation, the method comprising:
providing at least two airships coupled together with a coupling device;
terminating electrical connections between the at least two airships; and
terminating the attachment connections between the at least two airships such that the at least two airships are no longer in a physical relationship.
